(19) United States
(12) Patent Application Publication
(10) Pub. No.: US 2018/0269476 A1
(43) Pub. Date: Sep. 20, 2018

(54) Lithium Metal Oxide Material, the Use Thereof in a Positive Electrode of a Secondary Battery and a Method for Preparing such a Lithium Metal Oxide Material

(71) Applicants: Umicore, Brussels (BE); Umicore Korea Ltd., Chungnam (KR)

(72) Inventors: Xin XIA, Cheonan (KR); Jens PAULSEN, Daejeon (KR); Song-Yi HAN, Daejeon (KR)

(21) Appl. No.: 15/757,036

(22) PCT Filed: Aug. 29, 2016
(86) PCT No.: PCT/IB2016/055143

§ 371 Date: Mar. 2, 2018

(30) Foreign Application Priority Data
Sep. 11, 2015 (EP) 15184810.8
Sep. 23, 2015 (EP) 15186518.5

(51) Int. Cl. H01M 4/525; H01M 4/505; H01M 10/052; C01G 53/00

(52) U.S. Cl. CPC H01M 4/525; H01M 4/505; H01M 2004/028; C01G 53/54; H01M 10/052

(57) ABSTRACT

A powderous lithium metal oxide material having a cubic structure with space group Fd-3m and having the formula Li₁₋ₐ[(Ni_{b}Mna_{1-b})₁₋ₓTiₓA_{y}]2+ₐO₄ with 0.005≤x≤0.018, 0≤y≤0.05, 0.01≤a≤0.03, 0.18≤b≤0.28, wherein A is one or more elements from the group of the metal elements excluding Li, Ni, Mn and Ti.

### TECHNICAL FIELD AND BACKGROUND

The invention relates to a lithium metal oxide material, in particular a doped lithium-manganese-nickel based oxide, the use thereof in a positive electrode of a secondary battery and a method for preparing such a lithium metal oxide material.

Commercially available lithium-ion batteries typically contain a graphite-based anode and cathode materials. A cathode material is usually a powderous material capable of reversibly intercalating and de-intercalating lithium. In modern rechargeable batteries LiCoO₂ (LCO), Li₁₊ₐ(NiₓMn_{y}Co_{z})₁₋ₐO₂ (NMC) with approximately similar amounts of Ni, Mn, Co and LiMn₂O₄ (LMO) are the dominant cathode materials. LCO was firstly introduced as a cathode material for Lithium-ion batteries in 1990 by Sony. Since then, LCO has become the most widely used cathode material. Especially after commercialization of high voltage LCO, it dominates the market for portable electronics, such as smartphones and tablets. NMC was developed around 2000, to replace LCO through substitution of Co by Ni and Mn, due to the high price of Co metal. NMC has a gravimetric energy density comparable to LCO, but a lower volumetric energy density, due its to lower product density. Nowadays, NMC is mainly used for automotive applications, for example electrical vehicles (EV) and hybrid electrical vehicles (HEV). This is because NMC is much cheaper than LCO, and the automotive application requires less volumetric density than portable electronics.

LMO materials have been developed since the middle of the 1990s. LMO has a spinel structure with a ‘3D’ diffusion path of Li ions. It has been widely used for various applications, such as power tools, E-bikes, and in automotive applications. Compared to LCO and NMC, LMO is much cheaper and has a high Li diffusion ability. However, LMO has a lower theoretical specific capacity of 140 mAh/g, compared to 280 mAh/g for LCO and NMC. Therefore, to improve the gravimetric energy density of LMO, the only known approach is increasing the operation voltage.

In 1995, Dahn et al. disclosed a new compound LiMn_{1.5}Ni_{0.5}O₄ by substituting 0.5 Mn atom by 0.5 Ni atom in the formula of LiMn₂O₄. It was found that to fully delithiate LiMn_{1.5}Ni_{0.5}O₄, a charge voltage of 4.9 V (vs. Li) should be applied. LiMn_{1.5}Ni_{0.5}O₄ has a specific capacity similar to LiMn₂O₄. It also keeps the same crystal structure as LiMn₂O₄, hence its rate capability is very good. The gravimetric energy density of LiMn_{1.5}Ni_{0.5}O₄ however is significantly improved compared to LiMn₂O₄, due to the higher operating voltage. Since then, spinel type LiMn_{1.5}Ni_{0.5}O₄ (further referred to as “LMNO”) has become an important field of study and development of cathode materials.

However, the development of LMNO is facing several issues. Firstly, there is a lack of good electrolyte systems for very high voltage application, meaning circa 5V. Current applications of lithium-ion battery are focusing on an operating voltage below 4.5 V, for example, a lithium-ion battery for most smartphones operates at 4.35 V, and batteries for automotive application at about 4.1˜4.2 V. One of the main reasons for this low operating voltage is related to the electrolyte. Current organic solvents in the electrolyte, which are mainly linear and cyclic carbonates, start to decompose when the voltage is higher than 4.5 V, forming side products that negatively impact the cathode/electrolyte and anode/electrolyte interphase. Such side products deteriorate the electrochemical battery performance and cause a fast capacity fading. Research to improve the electrolyte stability at voltages >4.5 V is ongoing. Efforts include finding new solvents, inventing new salts, combining functional additives, etc.

Another critical issue for using LMNO is the problem of high voltage stability of the material itself. When charged to a high voltage, the dissolution of Mn becomes severe. Dissolved Mn migrates through the electrolyte and is deposited on the anode side, destroying the Solid Electrolyte Interphase (SEI) on the anode surface. During cycling of a battery, Mn continuously dissolves and destroys this SEI, thereby continuously consuming Li to form new SEI on the anode. This results in fast lithium loss and fast capacity fading in batteries.

An object of the present invention is therefore to provide LMNO cathode materials that are showing improved properties in terms of cycling stability, thermal stability, rate performance etc.

### SUMMARY

Viewed from a first aspect, the invention can provide the following product embodiments:

### Embodiment 1

A powderous lithium metal oxide material having a cubic structure with space group Fd-3m and having the formula Li₁₋ₐ[(Ni_{b}Mn_{1-b})₁₋ₓTiₓA_{y}]₂₊ₐO₄ with 0.005≤x≤0.018, 0≤y≤0.05, 0.01≤a≤0.03, 0.18≤b≤0.28, wherein A is one or more elements from the group of the metal elements excluding Li, Ni, Mn and Ti. It is needed to limit the Li/metal ratio (1−a)/(2+a) to avoid the formation of impurities or deteriorate the performance. A too low Li/metal ratio would result in the formation of impurities such as NiO, while a too high Li/metal ratio would result in increasing the ratio of Ni³⁺/Ni²⁺, which lowers the electrochemical reactivity of the material.

### Embodiment 2

The lithium metal oxide material according to the invention, wherein 0<y, wherein A comprises one or more of Al, Mg, Zr, Cr, V, W, Nb and Ru, wherein preferably A consists of one or more elements from the group of Al, Mg, Zr, Cr, V, W, Nb and Ru. As is clear from the above formula, A is a dopant. A dopant, also called a doping agent, is a trace impurity element that is inserted into a substance (in very low concentrations) in order to alter the electrical properties or the optical properties of the substance.

### Embodiment 3

In the lithium metal oxide material, x≤0.016. Up to a level of x=0.018, and more easily up to a level of x=0.016, Ti may be homogenously doped into the crystal structure of LMNO. This material shows improved cycle stability, rate capability, safety properties and high voltage stability when charged to 4.9V. Due to the improvements, such cathode materials show promising potential for various applications in lithium-ion battery, for example, power tools, E-bikes etc.

### Embodiment 4

In the lithium metal oxide material, 0≤y≤0.02 and (y/x)<0.5.

### Embodiment 5

The lithium metal oxide material according to the invention, wherein, in an X-ray diffractogram determined using Cu k-alpha radiation, the full width at half maximum of the peak with Miller index (111) and the full width at half maximum of the peak with Miller index (004) have a ratio of at least 0.6 and at most 1. In embodiment 5, the ratio of the full width at half maximum of the peak with Miller index (111) over the full width at half maximum of the peak with Miller index (004) is indicative for the strain inside the material. The bigger the ratio, the lower the strain inside of the material, but a certain strain is needed to achieve good electrochemical performance, while a too large strain indicates inhomogeneity inside of the material.

### Embodiment 6

The lithium metal oxide material according to the invention is a crystalline single phase material. Preferably the material has a spinel structure.

### Embodiment 7

The lithium metal oxide material according to the invention whereby Ti is homogeneously distributed inside the particles of the material.

It is clear that each of the individual product embodiments described hereabove can be combined with one or more of the product embodiments described before it.

Viewed from a second aspect, the invention can provide the following use embodiment 8: The use of the lithium metal oxide material according to the invention in a positive electrode for a secondary battery.

Viewed from a third aspect, the invention can provide the following method embodiments:

### Embodiment 9

A method for preparing the powderous lithium metal oxide material according to the invention, the method comprising the following steps:
providing a mixture comprising sources of Ni, Mn, Li, Ti and the element or elements comprised in A, whereby the relative amounts of the sources of Ni, Mn, Li, Ti and the element or elements comprised in A correspond to the formula of the lithium metal oxide material,
heat-treating the mixture at a first temperature for a first time period, whereby the first temperature is at least 900° C., thereby obtaining a first heat-treated mixture, and
heat-treating the first heat-treated mixture at a second temperature for a second time period, whereby the second temperature is at most 800° C. Especially this last step is important, as it allows the production of a material with a higher phase purity. Preferably, the second temperature is between 650° C. and 750° C. This method leads to a homogeneous Ti distribution, so that Ti can properly act as a dopant. Preferably, the sources of Ti and/or of the elements comprised in A are oxides.

### Embodiment 10

In the method the sources of Ni and Mn are formed by a coprecipitated Ni—Mn oxy-hydroxide or Ni—Mn carbonate, whereby the source of Ti is TiO₂, and wherein the TiO₂ is coated on the coprecipitated Ni—Mn oxy-hydroxide or Ni—Mn carbonate before the step of providing a mixture comprising sources of Ni, Mn, Li, Ti and the element or elements comprised in A. In a particular embodiment, the preferred source of Ti is a submicron-sized TiO₂ powder having a BET of at least 8 m²/g and consisting of primary particles having a d50<1 μm, the primary particles being non-aggregated.

### Embodiment 11

In the method the first temperature is at most 1000° C.

### Embodiment 12

In the method the first time period is between 5 and 15 hrs.

### Embodiment 13

In the method the second temperature is at least 500° C.

### Embodiment 14

In the method the second time period is between 2 and 10 hrs.

The invention further provides an electrochemical cell comprising the lithium metal oxide material according to the invention.

Here it is appropriate to mention the following prior art:
1) Höweling Andres et al: “Evidence of loss of active lithium in titanium-doped LiNi_{0.5}Mn_{1.5}O₄/graphite cells”, Journal of Power Sources, 274, Nov. 1, 2014, pp. 1267-1275;
2) N. V. Kosova et al: “Pecularities of structure, morphology, and electrochemistry of the doped 5V spinel cathode materials Li Ni_{0.5-x}Mn_{1.5-y}M_{x+y}O₄ prepared by mechanochemical way”, Journal of Solid State Electrochemistry, Sep. 2, 2015; 3) US2015/090926 A1;
4) J-H Kim et al: “Effect of Ti substitution for Mn on the structure of LiNi_{0.5}Mn_{1.5-x}TiₓO₄ and their electrochemical properties as Lithium Insertion Material”, Journal of the Electrochemcial Society, 151, No 11, Oct. 22, 2004, page A1911;
5) NI Lin et al: “JES Focus issue on intercalation compounds for rechargeable batteries, A strategy to improve cyclic performance of LiNi_{0.5}Mn_{1.5}O₄ in a wide voltage region by Ti-doping”, Journal of the Electrochemcial Society, Mar. 2, 2013, pp. 3036-3040.

Contrary to these documents, in the present invention the Li to metal ratio and the Ti content are selected to guarantee a homogeneous doping with Ti of the spinel structure that is phase-pure and has the space group of Fd-3m, and thus yielding an improvement of the electrochemical properties.

### BRIEF DESCRIPTION OF THE DRAWINGS

FIG. 1: An X-ray diffraction (XRD) pattern of a material according to the invention with indication of Miller index;

FIG. 2: Differential Scanning calorimetry (DSC) curves of materials according to the invention and of a material not according to the invention

### DETAILED DESCRIPTION

The authors discovered that LMNO cathode powders which contain Ti as a dopant have superior characteristics when used in Li-ion batteries. The existence of Ti doping can help to improve the cycle stability, rate capability, thermal stability and high voltage stability, which helps to promote the practical application of LMNO materials. Additional doping elements besides Ti may be optionally present.

The following characterization procedures were used:

X-Ray Diffraction (XRD)

X-ray diffraction was carried out using a Rigaku D/MAX 2200 PC diffractometer equipped with a Cu (K-Alpha) target X-ray tube and a diffracted beam monochromator, at room temperature in the 15 to 70 2-Theta (Θ) degree range. The lattice parameters of the different phases were calculated from the X-ray diffraction patterns using full pattern matching and Rietveld refinement methods. The FWHM of a selected peak is calculated using a software called “peak search” form Rigaku Corp with elimination of K-Alpha 2 diffraction.

Coin Cell Tests

A half cell (coin cell) was assembled by placing a Celgard separator between a positive electrode to be tested and a piece of lithium metal as a negative electrode, and using an electrolyte of 1M LiPF₆ in EC/DMC (1:2) between separator and electrodes. The positive electrode was made as follows: cathode material powder, PVDF and carbon black are mixed with a mass ratio of 90:5:5. Sufficient NMP was added and mixed in to obtain a slurry. The slurry was applied to an Al foil by a commercial electrode coater. Then the electrode was dried at 120° C. in air to remove NMP. The target loading weight of the electrode was 10 mg cathode material/cm². Then the dried electrode was pressed to obtain an electrode density of 1.8 g/cc, and dried again at 120° C. in vacuum before assembly of coin cells.

All coin cell tests in the present invention were performed using the procedure shown in Table 1, with the 1 C-rate being defined as 160 mAh/g. “E-Curr” and “V” signify the end current and cut-off voltage, respectively. At the first cycle, the DQ0.1 C (discharge capacity of the first cycle at a rate of 0.1 C) and IRRQ (irreversible capacity) were determined. The performance of cycle stability is obtained from cycle #7 to #60. The capacity fading at 0.1 C is represented by “Qfade0.1 C”. With DQ7 and DQ34 referring to the discharge capacity of cycle #7 and #34 respectively, Qfade0.1 C is calculated by the formula: Qfade0.1 C=(1−(DQ34/DQ7))/27*100*100 (in % per 100 cycles). The capacity fading at 1 C is represented by “Qfade1 C”. With DQ8 and DQ35 referring to the discharge capacity of cycle #8 and #35 respectively, Qfade1 C is calculated by the formula: Qfade1 C=(1−(DQ35/DQ8))/27*100*100. The capacity fading at 1 C/1 C (1 C charging and 1 C discharging) is represented by “Qfade1 C/1 C”. With DQ36 and DQ60 referring to the discharge capacity of cycle #36 and #60 respectively, the Qfade1 C/1 C is calculated by the formula: (1−(DQ60/DQ36))/24.

TABLE 1
coin cell testing procedure

| | Charge | | | Discharge | | |
|---|---|---|---|---|---|---|
| Cycle # | C-rate | E-Curr | V | C-rate | E-Curr | V |
| 1 | 0.10 | — | 4.9 | 0.10 | — | 3.0 |
| 2 | 0.25 | 0.05 C | 4.9 | 0.20 | — | 3.0 |
| 3 | 0.25 | 0.05 C | 4.9 | 0.50 | — | 3.0 |
| 4 | 0.25 | 0.05 C | 4.9 | 1.00 | — | 3.0 |
| 5 | 0.25 | 0.05 C | 4.9 | 2.00 | — | 3.0 |
| 6 | 0.25 | 0.05 C | 4.9 | 3.00 | — | 3.0 |
| 7 | 0.25 | 0.10 C | 4.9 | 0.10 | — | 3.0 |
| 8 | 0.25 | 0.10 C | 4.9 | 1.00 | — | 3.0 |
| 9-33 | 0.5 | 0.10 C | 4.9 | 1.00 | — | 3.0 |
| 34 | 0.25 | 0.10 C | 4.9 | 0.10 | — | 3.0 |
| 35 | 0.25 | 0.10 C | 4.9 | 1.00 | — | 3.0 |
| 36-60 | 1.00 | — | 4.9 | 1.00 | — | 3.0 |

Float Charge Method

In a recent technical report of commercially available “3M battery electrolyte HQ-115”, a float charging method is used to test the stability of a novel electrolyte at high voltage. The method is carried out by continuously charging LCO/graphite pouch cells or 18650 cells at 4.2 V and 60° C. for 900 hours. The currents recorded under charge are compared. A higher current reflects more side reactions that occur, so this method is able to identify parasite reactions occurring in a battery at high voltage. In “Energy Environ. Sci., 6, 1806 (2013)”, a similar float charging method is used to evaluate the stability of electrolyte against oxidation under high voltage from 5V and up to 6.3V vs. Li metal.

Based on the above knowledge, by choosing a relatively stable electrolyte and anode material for the required charging voltage, a float charge method was used to study the stability of cathode materials under high voltage, where the metal dissolution from the cathode materials can be reflected by the leakage current. In addition, in “Nature Comm., 4, 2437 (2013)”, manganese dissolved from a lithium manganese oxide cathode is deposited on the surface of the anode in metal or metal alloy form, and the deposited amount can be detected by inductively coupled plasma-atomic absorption spectrometry (ICP-AAS). This ICP experiment on the anode can also be used to study the metal dissolution issue of LMNO, doped or not.

Therefore, the float charge method associated with ICP measurement (referred to hereafter as “floating experiment”) is a feasible way to evaluate the side reaction and metal dissolution of LMNO cathode materials at high voltage and elevated temperature. For the Examples and Counter Example, floating experiments are performed in order to evaluate the stability of the cathode materials at high voltage charging and at elevated temperature (50° C.).

The tested cell configuration was a coin cell assembled as follows: two separators (from SK Innovation) are located between a positive electrode and a negative graphite electrode (from Mitsubishi MPG). The electrolyte was 1M LiPF₆ in EC/DMC (1:2 volume ratio) solvents. The prepared coin cell was submitted to the following charge protocol: the coin cell was firstly charged to a defined upper voltage (4.85V vs. graphite) at constant current mode with a C/20 rate taper current, and was then kept at constant 4.85V voltage for 144 hours at 50° C. The floating capacity was then calculated from the accumulated charge over these 144 hrs and the cathode material mass. After this procedure, the coin cells were disassembled. The anode and the separator in contact with the anode were analyzed by ICP-OES determine their Mn content, indicating Mn dissolved during the floating experiment.

DSC Measurements

Differential Scanning calorimetry (DSC) was performed by firstly making a coin cell as described above and charging it to 4.9 V vs. Li with a constant current of C/25. Then the coin cell was held at 4.9V with an end condition of current reducing to C/50. Then the coin cell was disassembled and the cathode electrode taken out. The cathode electrode was washed with dimethyl carbonate (DMC) twice to remove residual electrolyte, and dried at 120° C. for 10 minutes in vacuum. A 5 mm diameter round sample was punched from the electrode and used as a sample for DSC measurement, with circa 30% by weight of electrolyte added, using a closed DSC cell. A TA DSC Q10 instrument was used for the DSC test. The temperature range of test was from 50° C. to 350° C. using a temperature ramp of 0.5° C./min. Finally, the onset temperature of exothermic reaction and total heat generated are reported. They are indicative for the stability of the cathode when used in a battery.

The invention is further illustrated in the following Examples:

### Example 1 was Manufactured by the Following Steps

NiSO₄.6H₂O and MnSO₄.1H₂O, were dissolved in water to a summed total metal concentration of 110 g/L and having a Ni/Mn molar ratio of 0.21/0.79. An ammonia solution with NH₃ concentration of 227 g/L was prepared by diluting a concentrated ammonia solution with water to reach the desired concentration. An aqueous nanoparticulate TiO₂ suspension (385 g/L) was used as dopant feed and the concentration of NaOH solution was 400 g/L. The reactor was firstly charged with water and ammonia with the ammonia concentration of 15 g/L, and then heated up to 60° C. A Ti-doped metal hydroxide was then precipitated by continuously adding the Ni—Mn sulphate solution, the ammonia solution, the TiO₂ suspension and the NaOH solution into a continuous stirring tank reactor (CSTR) through the control of mass flow controllers (MFC) under a N₂ atmosphere. The precipitation process was controlled by changing the flow rate of the NaOH solution to reach the desired particle size, while the flow rates of the Ni—Mn sulphate solution, ammonia solution and the TiO₂ suspension were kept constant. After the particle size of the precursor reached the target, the flow rate of NaOH solution was fixed. The resulting overflow slurry was collected and was separated from the supernatant by filtration. After washing with water, the precipitated solid was dried in a convection oven at 150° C. under N₂ atmosphere. Chemical analysis of the obtained precursor material confirmed a composition consistent with [Ni_{0.21}Mn_{0.79}]_{0.985}Ti_{0.015} metal atomic ratio. Oxygen and hydrogen level indicated the product to be a mixed metal oxyhydroxide, and SEM fotograph showed 1-15 μm particles with fine TiO₂ particles embedded. Lithium carbonate and the obtained TiO₂ coated Ni—Mn oxy-hydroxide precursor were homogenously blended a vertical single-shaft mixer by a dry powder mixing process. The blend ratio was targeted to obtain the following composition with respect to the elements Li, Ni, Mn and Ti: Li_{0.988}[(Ni_{0.21}Mn_{0.79})_{0.985}Ti_{0.015}]_{2.012} which was verified by ICP. The distribution of Ti in the powder was homogeneous, as can be easily verified.

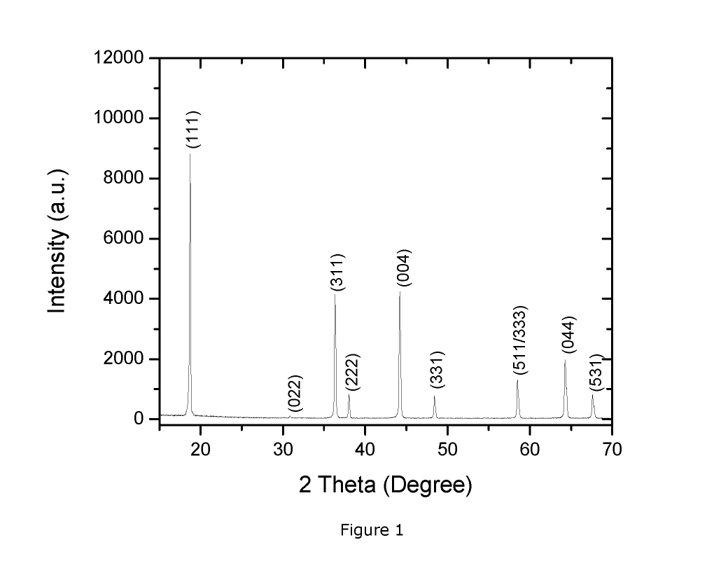

The obtained powder mixture was heat-treated in a box furnace at a temperature of 980° C. for 10 hrs. Then the temperature was lowered to 700° C. for a period of 5 hrs. In both stages dry air was flowing through the box furnace, so that an oxidizing atmosphere was established. The product was cooled to room temperature and milled to a particle size distribution with D50=14 μm. The finally obtained material was Li_{0.988}[(Ni_{0.21}Mn_{0.79})_{0.985}Ti_{0.015}]_{2.012}O₄. FIG. 1 shows the X-ray diffraction (XRD) pattern of Example 1, which corresponds to a crystalline single phase cubic spinel structure with space group Fd-3m.

### Example 2

Example 2 was manufactured by the same method as Example 1, with the difference that the ratio of Li to the other elements was changed to result in a material with a composition of: Li_{0.971}[(Ni_{0.21}Mn_{0.79})_{0.985}Ti_{0.015}]_{2.029}O₄.

### Counter Example 1

Counter Example 1 was manufactured by the following steps: Lithium carbonate and Ni—Mn oxy-hydroxide were homogenously blended in a vertical single-shaft mixer by dry powder mixing. The overall composition was targeted to obtain the following composition with respect to the elements Li, Ni and Mn: Li_{0.988}[Ni_{0.21}Mn_{0.79}]_{2.012}, which was verified by ICP. The same thermal treatment and milling treatment as for Example 1 was given to this blend.

### Counter Example 2

Counter Example 2 was manufactured by the same method as Example 2, with the difference that the ratio of Li to the other elements was changed to result in a material with a composition of: Li_{0.971}[(Ni_{0.21}Mn_{0.79})_{0.98}Ti_{0.020}]_{2.029}O₄, having a Ti content outside the range of the invention.

Examples 1 and 2 and Counter Example 1 were submitted to the abovementioned characterizations, Counter Example 2 was only submitted to XRD and coin cell measurement, and the following results were obtained: Table 2 summarizes the ratios FWHM₍₁₁₁₎/FWHM₍₀₀₄₎, and Table 3 summarizes the coin cell performance when the coin cells are charged to 4.9 V.

TABLE 2
XRD based ratios

| | FWHM₍₁₁₁₎/FWHM₍₀₀₄₎ |
|---|---|
| Example 1 | 0.746 |
| Example 2 | 0.963 |
| Counter | 1.068 |
| Example 1 | |
| Counter | 1.021 |
| Example 2 | |

TABLE 3
electrochemical performances of coin cells

| | DQ of 1^{st} cycle | Qfade0.1 C | Qfade1 C | Qfade1 C/1 C |
|---|---|---|---|---|
| | (mAh/g) | (%) | (%) | (%) |
| Example 1 | 138.66 | 1.24 | 1.57 | 6.03 |
| Example 2 | 140.45 | 1.04 | 1.26 | 2.60 |
| Counter | 138.42 | 2.90 | 3.82 | 20.35 |
| Example 1 | | | | |
| Counter | 138.26 | 6.20 | 8.74 | 20.55 |
| Example 2 | | | | |

Example 1 and Example 2 show improved cycle stability compared to Counter Example 1 and Counter Example 2, as is particularly clear from the much lower Qfade values.

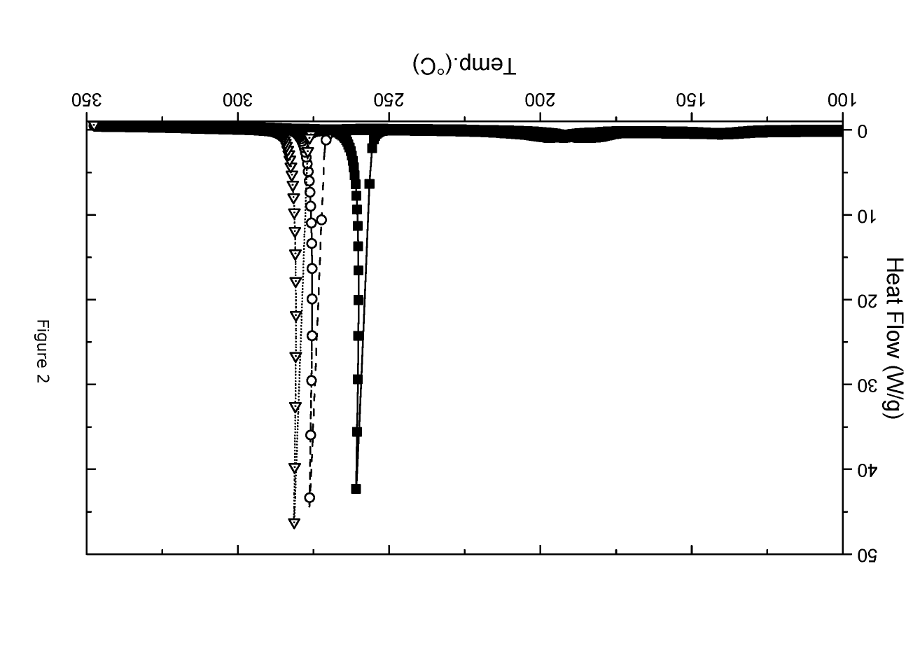

FIG. 2 shows the DSC curves of the Examples and Counter Example 1, with the open circles indicating Example 1, with the open triangles indicating Example 2, and with the filled squares indicating Counter Example 1. The onset temperatures and integrated heat from the DSC curves are also given in Table 4.

TABLE 4
DSC data

| | On-set temperature | Total heat |
|---|---|---|
| | (° C.) | (kJ/g) |
| Example 1 | 270.4 | 1.61 |
| Example 2 | 276.9 | 1.63 |
| Counter | 255.7 | 1.73 |
| Example 1 | | |

Example 1 and Example 2 have higher onset temperatures of the exothermic peaks, and their total heat values are smaller than for Counter Example 1. Overall this means that Example 1 and Example 2 show improved thermal stability compared to Counter Example 1, which is related to improved safety of the real cells using such cathode materials.

Table 5 shows the results of the floating experiments. Examples 1 and 2 show a significantly lower floating capacity and Mn dissolution than Counter Example 1. This indicates a better high voltage stability for Examples 1 and 2 compared to Counter Example 1.

TABLE 5
data of floating experiments

| | Floating capacity | Mn dissolution |
|---|---|---|
| | (mAh/g) | (mg) |
| Example 1 | 72.96 | 0.0139 |
| Example 2 | 71.45 | 0.0109 |
| Counter | 115.78 | 0.0161 |
| Example 1 | | |

1-14. (canceled)

15. A powderous lithium metal oxide material having a cubic structure with space group Fd-3m and having the formula Li₁₋ₐ[(Ni_{b}Mn_{1-b})₁₋ₓTiₓA_{y}]₂₊ₐO₄ with 0.005≤x≤0.018, 0≤y≤0.05, 0.01≤a≤0.03, 0.18≤b≤0.28, wherein A is one or more elements from the group of the metal elements excluding Li, Ni, Mn and Ti.

16. The lithium metal oxide material of claim 15, wherein 0<y, wherein A comprises one or more of Al, Mg, Zr, Cr, V, W, Nb and Ru.

17. The lithium metal oxide material of claim 15, wherein 0.005≤x≤0.016.

18. The lithium metal oxide material of claim 15, wherein 0≤y≤0.02 and (y/x)<0.5.

19. The lithium metal oxide material of claim 15, wherein, in an X-ray diffractogram determined using Cu k-alpha radiation, the full width at half maximum of the peak with Miller index (111) and the full width at half maximum of the peak with Miller index (004) have a ratio of at least 0.6 and at most 1.

20. The lithium metal oxide material of claim 15, whereby the lithium metal oxide material is a crystalline single phase material.

21. The lithium metal oxide material of claim 15, whereby Ti is homogeneously distributed inside the particles of the material.

22. The use of the lithium metal oxide material of claim 15 in a positive electrode for a secondary battery.

23. A method for preparing a powderous lithium metal oxide material according to claim 1, the method comprising:
providing a mixture comprising sources of Ni, Mn, Li, Ti and the element or elements comprised in A, whereby the relative amounts of the sources of Ni, Mn, Li, Ti and the element or elements comprised in A correspond to the formula of the lithium metal oxide material,
heat-treating the mixture at a first temperature for a first time period, whereby the first temperature is at least 900° C., thereby obtaining a first heat-treated mixture, and
heat-treating the first heat-treated mixture at a second temperature for a second time period, whereby the second temperature is at most 800° C.

24. The method according to claim 23, wherein the sources of Ni and Mn are formed by a coprecipitated Ni—Mn oxy-hydroxide or Ni—Mn carbonate, whereby the source of Ti is TiO₂, and wherein the TiO₂ is coated on the coprecipitated Ni—Mn oxy-hydroxide or Ni—Mn carbonate before the step of providing a mixture comprising sources of Ni, Mn, Li, Ti and the element or elements comprised in A.

25. The method according to claim 23, wherein the first temperature is at most 1000° C.

26. The method according to claim 23, wherein the first time period is between 5 and 15 hrs.

27. The method according to claim 23, wherein the second temperature is at least 500° C.

28. The method according to claim 23, wherein the second time period is between 2 and 10 hrs.
